(19) United States
(12) Patent Application Publication
(10) Pub. No.: US 2005/0281944 A1
(43) Pub. Date: Dec. 22, 2005

(54) Fluid-assisted self-assembly of meso-scale particles

(76) Inventor: Bor Z. Jang, Fargo, ND (US)

Correspondence Address: Bor Z. Jang, 2902, 28 AVE, S.W., FARGO, ND, 58103, US

(21) Appl. No.: 10/868,987

(22) Filed: Jun. 17, 2004

(51) Int. Cl. B05D 1/12

(52) U.S. Cl. 427/180

(57) ABSTRACT

A method for the preparation of a monolayer of meso-scaled particles within a size range of one nanometer to several hundreds of microns. The method includes the steps of (A) providing a thin liquid film onto an external surface of a rotary member; (B) dispensing meso-scaled particles at a desired rate onto an external surface of the thin liquid film so as to position the particles at a gas-liquid interface; (C) forming a uniform monolayer of the particles on the gas-liquid interface; and (D) transferring the monolayer from the gas-liquid interface to a solid substrate. Monolayers of meso-scaled particles on solid surfaces are useful in many areas of science and technology, including functional coatings that modify the physical and chemical properties of the underlying surfaces. The method is particularly useful for the preparation of catalyzed proton exchange membranes for fuel cell applications.

### FIELD OF THE INVENTION

The present invention relates generally to self-assembly, and more particularly to fluid-assisted self-assembly of meso-scaled particles, including those spanning the size range of one nanometer to several hundred microns, into a monolayer to produce a thin film or thin coating.

### BACKGROUND OF THE INVENTION

Self-assembly means the spontaneous association of entities (atoms, molecules, nanometer- or micron-sized particles, and macroscopic objects or devices) into a structural aggregate. The best-known and most well-studied area of self-assembly involves molecular self-assembly. This spontaneous association of molecules is a successful strategy for the generation of large, structured molecular aggregates.

Self-assembly of molecules can be made to occur spontaneously at a liquid/solid interface to form a self-assembled monolayer (SAM) of the molecules. This is accomplished when the molecules have a shape that facilitates ordered stacking in the plane of the interface and each includes a chemical functionality that adheres to the surface or somehow promotes arrangement of the molecules with the functionality positioned adjacent the surface. For instance, in U.S. Pat. No. 5,512,131 (Apr. 30, 1996), Kumar and Whitesides describe several techniques for arranging patterns of self-assembled monolayers at surfaces for a variety of purposes.

Self-assembly of components larger than molecules to form monolayers is also known. Examples include self-assembly of bubbles at an air-liquid interface, small spheres self-assembled on surfaces, and self-assembly of micro-spheres via biochemical attraction between the micro-spheres. The technology of coating a substrate with a particular type of monolayer thick random array of colloidal particles is described by Iler in U.S. Pat. No. 3,485,658 (Dec. 23, 1969) and by Peiffer and Deckman in U.S. Pat. No. 4,315,958 (Feb. 16, 1982). These coating techniques deposit a random array of colloidal particles on the substrate utilizing an electrostatic attraction.

Formation of ordered colloidal particle arrays by spin coating was disclosed by Deckman and Dunsmuir in U.S. Pat. No. 4,407,695 (Oct. 4, 1983). Ordering of the particles occurs because the sol flows across the substrate at high shear rates while the excess coating material is being dispelled to produce densely packed micro-scaled ordered arrays. The colloid must wet the substrate and the spin speed must be optimized. If the spin speed is too low a multilayer coating will be produced, and if the final spin speed is too high voids will be formed in the monolayer coating. Other factors such as rheology of the sol, particulate concentration, substrate surface chemistry, and differential charge between the substrate and the colloid must be optimized for each particle size. A systematic method for optimizing these factors requires detailed understanding of the dynamics of the coating process which is not presently available. For spheres outside the 0.3-1.0 μm size range, optimization of the coating process can be quite difficult.

An improved method of producing a relatively defect-free, close packed coating of colloidal particles on a substrate was disclosed by Dunsmuir, et al. in U.S. Pat. No. 4,801,476 (Jan. 31, 1989). The method includes the steps of forming a monolayer of particles at a liquid-gas (air) interface, compressing the monolayer of particles on the liquid surface, removing the compressed layer of particles from the liquid surface onto a substrate, and drying the substrate.

In U.S. Pat. No. 5,545,291 (Aug. 13, 1996), Smith, et al. disclose assembly of solid micro-devices in an ordered manner onto a substrate through fluid transfer, a process known as fluidic self-assembly (FSA) in the microelectronic packaging industry. The micro-devices are regularly-shaped blocks (e.g., rectangles) that, when transferred in a fluid slurry poured onto the top surface of a substrate having recessed regions that match the shapes of the blocks, insert into the recessed regions via gravity. In U.S. Pat. No. 5,355,577 (Oct. 18, 1994), Cohn describes a method of assembling discrete microelectronic or micro-mechanical devices by positioning the devices on a template, vibrating the template and causing the devices to move into apertures. The shape of each aperture determines the number, orientation, and type of device that it traps. Bowden, et al., in U.S. Pat. No. 6,507,989 (Jan. 21, 2003), describe self-assembly of meso-scale objects. Self-assembling systems disclosed include component articles that can be pinned at a fluid/fluid interface, or provided in a fluid, or provided in proximity of a surface, and caused to self-assemble via agitation.

The formation of a monolayer of insoluble molecules at a gas-liquid interface was typically accomplished through the use of troughs usually full of aqueous solutions. A solution containing amphiphilic molecules is usually spread to the gas-water interface. These molecules are typically made of a polar head and a chain of fatty acids. The volatile solvent is then evaporated, leaving behind the self-organized amphiphilic molecules at the gas-liquid interface. Finally, a mobile barrier compresses the molecules in the monolayer. Essentially, there occurs an immobile trough containing a stationary sub-phase on which molecules are laterally transported through it by exploiting the surface tension difference between the sub-phase and the deposited solution.

While self-assembly at the molecular level is relatively well-developed, this is not the case for self-assembly at larger scales. Many systems in science and technology require the assembly of components that are larger than molecules into assemblies, for example, micro-electronic and micro-electrochemical systems (MEMS), sensors, and micro-analytical and micro-synthetic devices. Photolithography has been the principal technique used to make micro-devices. However, photolithography cannot easily be used to form non-planar and three-dimensional structures, it generates structures that are metastable, and it can be used only with a limited set of materials.

The transfer of a monolayer of molecules or meso-scaled particles (e.g., 1 nm to 200 μm) onto a solid substrate may be realized through several methods. The so-called Langrnuir-Blodgett (LB) method essentially comprises vertically immersing a solid plate in the sub-phase through the monolayer of molecules and pulling up such a plate so that the layer is transferred onto the plate by lateral compression. These steps can be repeated many times. The LB method is normally used for transferring a monolayer of molecules only, not a monolayer of meso-scaled particles.

The so-called Langmuir-Schaeffer method comprises lowering an horizontal plate onto the monolayer. After a contact is made, the plate is again retracted with the monolayer on it. An improved version of the method involves making a cylinder rotate under the water surface. Such movement is expected to drive the insoluble particles ahead in a forming monolayer. However, in the majority of cases, this technique requires a pre-compression of an already prepared monolayer.

In U.S. Pat. No. 6,284,310 (Sep. 4, 2001), Picard proposed a method based on the concept of dynamic thin laminar flow (DTLF). The DTLF method for the preparation of a monolayer of particles or molecules, comprises (a) injecting a thin liquid film containing the particles or molecules onto an external surface of a rotary member; (b) adjusting the surface charge density of the particles or molecules through the injection of an adsorption reagent, thereby carrying these particles or molecules to a gas-liquid interface of the thin liquid film; (c) forming a uniform monolayer of these particles or molecules on the gas-liquid interface; (d) transferring the monolayer from the gas-liquid interface to a solid substrate; and (e) moving the rotary member in a longitudinal direction relative to the substrate, thereby separating the monolayer from the thin liquid film and adsorbing the monolayer to the substrate. This could be a powerful method for the formation and transfer of a monolayer of particles since it is fast and can be adapted for mass production of monolayer-based films or coatings. However, this prior-art DTLF method has the following shortcomings. First, when applied to the deposition of fine particles, this method is limited to the formation of regularly-shaped particles only (mostly spherical). Its applicability to irregularly-shaped particles has yet to be demonstrated. Second, the method requires adjusting the surface charge density of the particles through the injection of an adsorption reagent (an additional injector device being needed and the reagent being a potential source of contamination). Electrostatically driven migration of the particles immersed in a liquid phase to the liquid-air interface is not easy to implement and is not always effective.

Hence, it is an object of the present invention to provide an effective method of forming a monolayer from meso-scaled particles.

It is another object of the present invention to provide a method for preparing a monolayer from both regularly and irregularly shaped meso-scaled particles.

It is still another object of the invention to provide a method for forming a monolayer directly from discrete powder particles, not originally in a suspension form.

It is a further object of the present invention to provide a method of forming a monolayer of meso-scaled particles from a solution that contains a solid component dissolved in a liquid solvent.

### SUMMARY OF THE INVENTION

For the purpose of defining the claims, the meso-scaled particles mean those discrete particles that are not individual molecules, but may be clusters of multiple molecules or atoms that are bonded to become solid powder particles, or micro- or nano-devices or structures. These particles, devices or structures have at least one dimension in the range of 1 nanometer to several hundreds of microns (but preferably smaller than 100 microns). These can be glass beads, ceramic spheres, carbon aggregates, graphite plates, metal droplets, polymer granules, protein clusters, composite particles, micro-chips, nano-devices, etc. with a dimension in the range of 1 nm to 100 μm.

A preferred embodiment of the present invention is a method for the preparation of a monolayer of meso-scaled particles. The method includes the steps of (A) providing a thin liquid film onto an external surface of a rotary member (e.g., a cylinder or drum); (B) dispensing meso-scaled particles (by using a micro-powder feeder or a suspension dispenser) at a desired rate onto an external surface of the thin liquid film so that the particles are positioned at a gas-liquid interface; (C) forming a uniform monolayer of the particles on the gas-liquid interface; and (D) transferring the monolayer from the gas-liquid interface to a solid substrate, possibly by moving the rotary member in a longitudinal direction relative to the substrate, thereby separating the monolayer from the thin liquid film and adsorbing the monolayer to the substrate. Alternatively, step (B) may comprise dispensing a solution (containing a solid component dissolved in a solvent) onto the liquid thin film, which is a non-solvent for this solid component, so that the solid component precipitates out as discrete particles at the air-liquid interface. The thin liquid film preferably has a thickness in the range of 0.1 to 10 microns, further preferably in the thickness range of 0.5 to 5 microns.

The substrate is preferably a flexible substrate material in a film or sheet form that is fed from a feed roller and, after being adsorbed with the monolayer in step (D), is collected on a take-up roller. The substrate may be hydrophilic or hydrophobic. The substrate may comprise a material selected from the group consisting of a clean glass plate, a mica sheet, a quartz, a semiconductor, a metal, a polymer, a composite, and a solid electrolyte membrane. The apparatus used may feature a thin liquid film regulator that contains a sucking pump to suck the thin liquid film away from the substrate or to suck excess liquid from the thin film to maintain a constant thickness liquid film. The particles may be regularly-shaped (e.g., spherical, ellipsoidal, and cylindrical) or irregularly-shaped.

A particularly useful application of the presently invented process is the preparation of a catalyst-coated membrane for a fuel cell. In this application, the particles may comprise catalyst particles and the substrate may be a solid electrolyte membrane. A monolayer of catalyst particles, such as carbon black or graphite platelet particles carrying discrete nanometer-scaled platinum particles thereon, may be formed and transferred to a surface of a proton exchange membrane (PEM such as Nafion from du Pont Co.). Heat may be applied to soften the membrane and the catalyst monolayer may be compressed against the membrane to promote an intimate contact between the catalyst layer and the membrane. We have found that the amount of platinum catalyst required to operate a PEM-based hydrogen fuel cell or a direct methanol fuel cell is dramatically reduced (in some cases, by more than 50 times). Carbon-supported catalysts for fuel cell applications are described in Petrow, et al., U.S. Pat. No. 4,044,193 (Aug. 23, 1977); Wilson, U.S. Pat. No. 5,211,984 (May 18, 1993); Perpico, et al., U.S. Pat. No. 5,677,074 (Oct. 14, 1997); and Zelenay, et al., U.S. Pat. No. 6,696,382 (Feb. 24, 2004).

### BRIEF DESCRIPTION OF THE DRAWINGS

FIG. 1 Schematic of a prior-art apparatus for the formation of monolayers. A suspension dispenser 15, an adsorption reagent injection device 33, and a suction pump 13 are required to operate the apparatus.

FIG. 2 Schematic of an apparatus for the formation of monolayers according to one of the preferred embodiments of the present invention. A powder feeder or suspension dispenser 14 is used to deliver meso-scaled particles 18 directly to the surface of a thin liquid film 16.

FIG. 3 Schematic of an apparatus for the formation of monolayers according to another preferred embodiment of the present invention. The substrate moves in the same direction as the tangential linear velocity at the bottom of the rotating drum (in the negative X-direction).

FIG. 4 Schematic of an apparatus for the formation of monolayers according to another preferred embodiment of the present invention. A pair of heated rollers are used to consolidate the monolayer with the substrate to promote better contact or adhesion between the monolayer and the substrate.

FIG. 5 Schematic of an apparatus for the formation of monolayers according to another preferred embodiment of the present invention. A supporting platform 34 and a second rotary member 40 are used to create a more effective particle converging zone.

FIG. 6 Schematic of an improved apparatus (over the prior-art apparatus indicated in FIG. 1) for the formation of monolayers according to another preferred embodiment of the present invention. A supporting platform 34 and a second rotary member 40 are used to create a more effective particle converging zone. This configuration is particularly useful for the formation of monolayers from irregularly shaped particles.

FIG. 7 Schematic of an apparatus for the formation of monolayers according to another preferred embodiment of the present invention. A supporting platform 44 and a second rotary member 40 are used to create a more effective particle converging zone.

FIG. 8 Cell voltage-current density curves of a baseline (comparative) fuel cell sample and sample A.

### DETAILED DESCRIPTION OF THE INVENTION

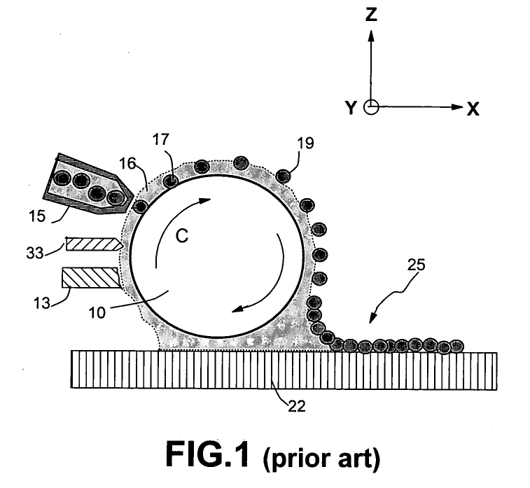

The prior-art apparatus shown in FIG. 1, according to Picard, et al. in U.S. Pat. No. 6,284,310, (Sep. 4, 2001), comprises a rotary member 10, in this case a clockwise-rotating cylinder. Connected to this cylinder is a module being equipped with three openings with respective inlet and outlet channels for the fluid. The first is a suspension dispenser 15 through which a thin liquid film 16 is injected. This film 16 contains a suspension of particles or proteins 17. The second is a reagent dispenser 33 through which an adsorption reagent is injected into the liquid film 16 so as to change the charge density of the particles 17. The third is a suction pump 13 to suck the thin liquid film after the monolayer 25 is transferred to a solid substrate 22.

The particles 17 are originally dispersed and immersed in a liquid. After their surface charge density is modified by means of contact with an adsorption reagent, they are carried to the surface, i.e., now being adsorbed at the gas-liquid interface. The rotation of the rotating member (arrow C) pushes particles 19 one against another to form a continuous and uniform monolayer 25. To facilitate subsequent discussions, the axial direction of the cylinder is defined to be the Y-direction (transverse direction) of a horizontal plane (X-Y plane), shown in FIG. 1. The Y-direction is going into the paper. The gravitational force direction may be conveniently defined as the vertical or Z-direction. The other horizontal direction, perpendicular to both Y- and Z-directions, is referred to as the X- or longitudinal direction.

As indicated in FIG. 1, by rotating the cylinder clockwise and, concurrently, translating the substrate 22 relative to the cylinder in the longitudinal direction (X-direction), one is able to transfer the monolayer 25 to the top surface of the substrate 22. The thin liquid film is then sucked away by the suction means 13.

According to Picard, U.S. Pat. No. 6,284,310 (Sep. 4, 2001), the afore-mentioned dynamic thin laminar flow (DTLF) method must meet two requirements: the presence of a liquid sub-phase of approximately 1 to 10 micron thick and one mobile surface on which this thin layer of liquid resides. This thinness is essential to the DTLF process because the particles in the thin liquid film will have to phase-separate or precipitate from inside the liquid film and emerge to the gas-liquid interface, induced by the mobile solid surface. A thin liquid film means a very small liquid volumes, in the micro-liter range. This implies that it will take only a small amount of a charge modifier fluid (e.g., a buffer or solution) in order to change the physico-chemical features of the liquid film for promoting the phase separation.

That the surface (on which the thin liquid film rests) is moving is also an important feature. Due to the viscosity of the liquid, this movement drives the solid-liquid interface with the driving force being transmitted layer by layer from the moving surface (e.g., the external surface of a rotating drum) up to the air-liquid interface. These movements provoke the convection in the thin liquid film that effectively transports particles towards the gas-liquid interface. However, the method proposed by Picard, et al. requires the adjustment of surface charge densities of the particles in order to achieve the phase separation or precipitation of the particles from the liquid and the eventual adsorption of particles at the gas-liquid interface.

The primary controlling parameters with the DTLF method are the ionic forces in the sub-phase (for the particle adsorption at the air-liquid interface) and the surface forces (compressing the particles into a monolayer). The surface forces depend only on the cylinder rotation speed and the thickness of the thin liquid film. A reduction in the repulsive forces between particles provokes the particle-particle adsorption at the gas-liquid interface. This would result in the aggregation of particles on the liquid surface to form a monolayer. This is why, in the invention of Picard, et al., a charge modifier is injected into the liquid film to induce the precipitation of particles from the liquid film.

The method of Picard, et al. begins the monolayer formation process with the preparation of a suspension or solution (containing a solid dissolved in a liquid). This suspension or solution is then dispensed onto the external surface of a rotating drum to form a thin liquid film (sub-phase) thereon. A surface charge density modifier in a liquid form (adsorption reagent) is then injected into the sub-phase to induce the desired surface precipitation of particles.

By contrast, preferred embodiments of the presently invented method typically involve directly dispensing individual particles across the width (transverse direction) of the thin liquid film surface on a rotating drum (cylinder). No adsorption reagent is needed in these cases. The surface tension and the laminar flow field would prevent the particles from immersing into the liquid film. Individual meso-scaled particles are deposited uniformly or randomly across the Y- or transverse direction and, preferably intermittently, along the X- or longitudinal direction with some interval space between two lines or bands of particles. These particles are transported to the top of the drum and then go downhill thereafter. The fact that the surface, on which the thin liquid film rests, is moving implies that the downward-moving particles are compressed against the edge of the growing monolayer. Particles arrive one after another in a compression zone (also referred to as a converging zone). This sequence of arrival is very favorable for the formation of large two-dimensional ordered structures with particles. In principle there is no limitation on the size of particles and the nature of the material involved.

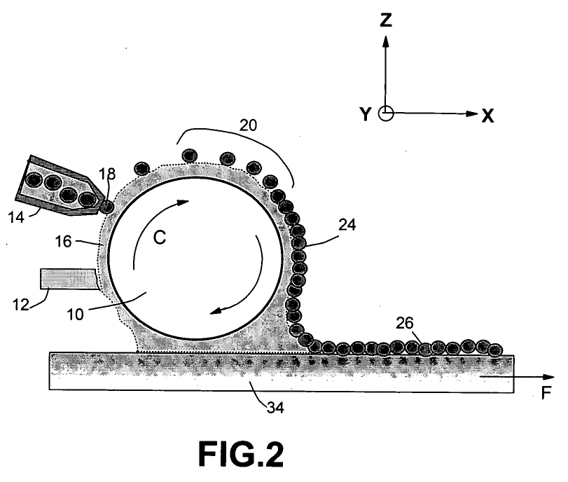

As a preferred embodiment, FIG. 2 shows an apparatus that can be used to practice the presently invented method. The apparatus comprises a rotary member 10, in this case a clockwise-rotating cylinder. On the left hand side of this cylinder is a module being equipped with two material handling devices. The first is a combined liquid dispensing and suction device 12 that operates to deposit and maintain a thin liquid film 16 on the external surface of the rotary cylinder. This device serves to inject a liquid (e.g., water) onto the cylinder surface to form a thin liquid film and to suck excess liquid from the cylinder once a monolayer 26 is transferred to the top surface of a substrate 22. The second device is a micro-powder dispenser 14 that discharge meso-scaled particles 18 onto the surface of the thin liquid film (at the air-liquid interface). This powder dispenser may be a piezoelectric- or ultrasonic-driven micro-powder feeder. The powder dispenser may be a fluidized-bed based powder manipulator that is capable of spraying a dilute layer of mostly separated particles onto the surface of the thin liquid film.

Alternatively, the second device may be a suspension dispenser through which a mixture of meso-scaled particles and a liquid matrix (with the particles dispersed in the liquid matrix) is dispensed onto the surface of the thin liquid film. This matrix material may be a material identical to or compatible with the thin liquid film material. We have found that the pre-existence of a liquid thin film, provided by the combined liquid dispensing and suction device 12, promotes the relocation of the dispersed particles in a suspension (dispensed from device 14) to the air-liquid interface. The matrix liquid gradually merges into the thin liquid film, but the solid particles somehow move to or stay on top of the liquid film possibly due to the thin laminar flow effect.

The apparatus in FIG. 2 further comprises a substrate 22 on which the monolayer 26 is deposited. The particles 18 are originally separated from one another at the air-liquid interface. The rotation of the rotating member (arrow C) compresses particles 18 one against another to converge to a continuous and uniform monolayer 24. This converging zone 20, also referred to as the compression zone, arises primarily due to the difference between the speed at which particles come downhill and the speed at which the monolayer is transferred to the substrate 22. Preferably, the tangential (linear) speed of the downhill-moving particles is made to be slightly faster than the translational motion speed of the substrate relative to the cylinder.

Hence, a preferred embodiment of the present invention is a method for the preparation of a monolayer of meso-scaled particles within a size range of one nanometer to several hundreds of microns. The method includes the steps of (A) providing a thin liquid film onto an external surface of a rotary member; (B) dispensing meso-scaled particles at a desired rate onto an external surface of the thin liquid film so that the particles are positioned at a gas-liquid interface; (C) forming a uniform monolayer of the particles on the gas-liquid interface; and (D) transferring the monolayer from the gas-liquid interface to a solid substrate. This can be accomplished by moving the rotary member in a longitudinal direction relative to the substrate, thereby separating the monolayer from the thin liquid film and adsorbing the monolayer to the substrate.

Further alternatively, the second device of the module (left hand side of FIG. 2) may be a solution dispenser that dispenses a solution (a solid component dissolved in a solvent) onto the thin liquid film. The thin liquid film material is selected to be a non-solvent for the solid component so that the solid component will precipitates out as single-layer meso-scaled particles when the solution dispensed is brought in contact with the thin liquid film material. The particles precipitated out of the mixture were found to stay at the air-liquid surface.

### EXAMPLES 1

One of the examples that we have studied entails preparation of a polystyrene-toluene solution (2% by weight of polystyrene in 98% solvent). When the solution was injected onto the thin liquid film (water) on a rotating drum, polystyrene particles several microns in diameter were precipitated out to the external surface of the film; i.e., at the air-water interface. These particles were then compressed against each other to form a monolayer.

Hence, another embodiment of the present invention is a method for the preparation of a monolayer of meso-scaled particles, including the steps of (a) injecting a first liquid to form a thin liquid film on an external surface of a rotary member with the first liquid being a non-solvent to a desired solid component; (b) injecting a solution (comprising the solid component dissolved in a liquid solvent) onto the thin liquid film (a non-solvent), thereby causing the solid component to precipitate out in the form of meso-scaled particles at a gas-liquid interface of the thin liquid film; (c) forming a uniform monolayer of the particles on the gas-liquid interface; and (d) transferring the monolayer from the gas-liquid interface to a solid substrate. Step (d) may include moving the rotary number in a longitudinal direction relative to the substrate, thereby separating the monolayer from the thin liquid film and adsorbing the monolayer to the substrate.

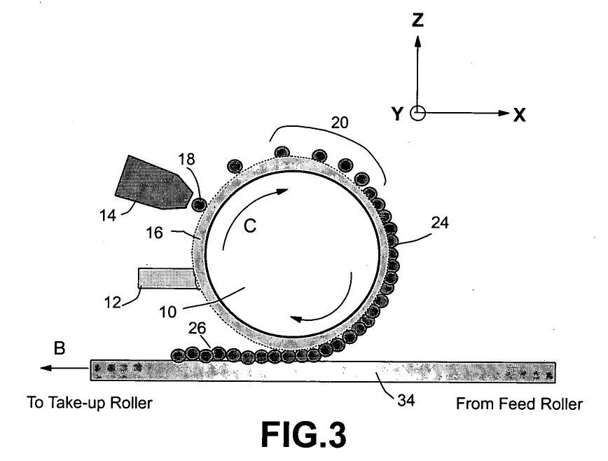

Schematically shown in FIG. 3 is another preferred embodiment of the present invention. In this case, the translational motion direction (designated by the letter B) of the substrate is the same as the rotational motion direction as defined by the tangential velocity direction of the cylinder at the bottom of the cylinder (near the substrate). In this case, the substrate translation direction is along the negative X-direction and so is the rotational motion direction. In all cases, it is highly advantageous to use a flexible substrate such as a plastic or paper which can be fed from a feed roller and collected at a take-up roller. This makes it possible to have a roll-to-roll or reel-to-reel process which is amenable to mass production of a thin film or coating.

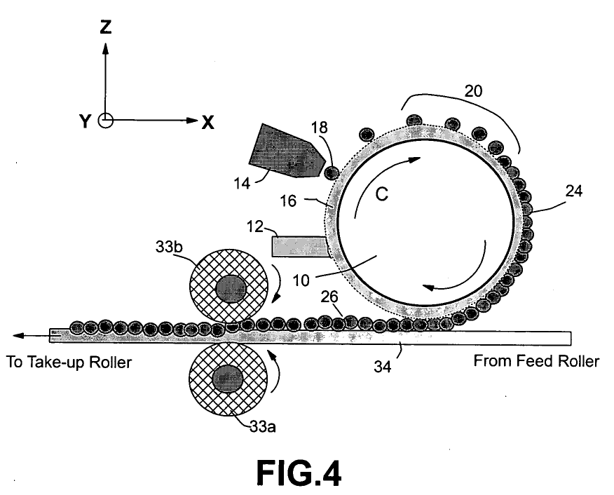

It may be noted that upon deposition of a monolayer to a substrate, the monolayer and/or the substrate may be subjected to a physical or chemical treatment (e.g., a heat treatment). As shown in FIG. 4, the monolayer-coated substrate may go through a thin gap between two heated rollers 53a & 53b. This would allow the monolayer to have a more intimate contact with the substrate (e.g., monolayer slightly embedded into a polymer substrate, which becomes softened when heated). This step of treating may comprise exposing the monolayer and/or substrate to a high energy beam selected from the group consisting of ultraviolet light, infrared light, microwave, radio frequency, plasma, electron beam, ion beam, laser, radiant heat, convective heat, conduction heat, heat transferred from a heated roller, and combination thereof.

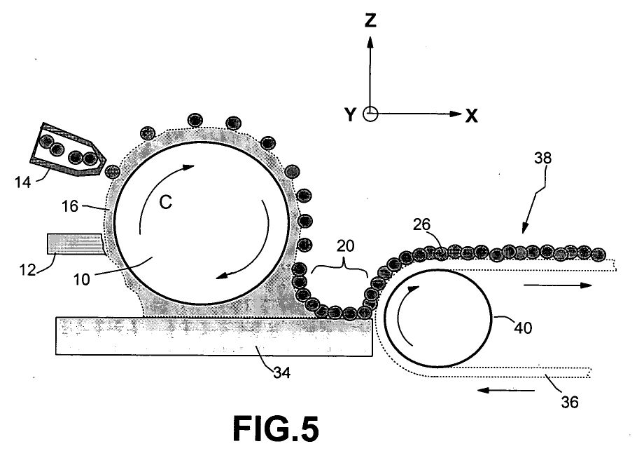

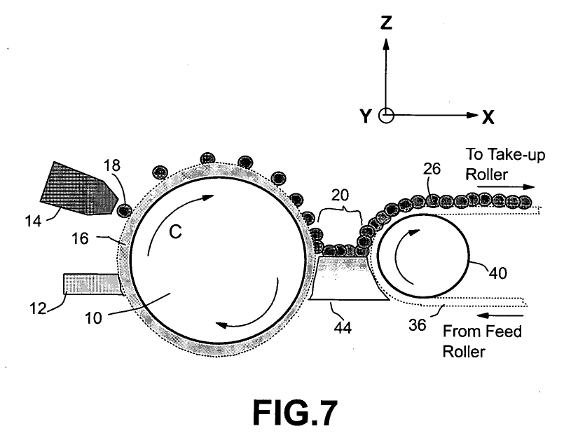

In another preferred embodiment, schematically shown in FIG. 5 and FIG. 7, a converging zone 20 may be constituted by operating a second rotary member (e.g., a cylinder 40) that rotates at a slightly lower linear (tangential) speed than that of the first cylinder 10. A supporting platform (34 in FIGS. 5 and 44 in FIG. 7) is used to tentatively support the monolayer being formed before the monolayer 26 is transferred to a substrate 36 that is supported on and driven by the second rotating member 40. The monolayer-coated substrate 38 may then be collected on a winding roller. Therefore, as another preferred embodiment, the method includes the steps (A) providing a thin liquid film onto an external surface of a first rotary member; (B) dispensing meso-scaled particles at a desired rate onto an external surface of the thin liquid film; (C) providing a converging zone on which the particles are compressed to form a monolayer which is gradually separated from the external surface of the thin liquid film (gas-liquid interface); and (D) transferring the monolayer from the converging zone to a solid substrate. Step (D) may comprise transferring the monolayer to a surface of the solid substrate which is driven by a second rotary member. This second rotary member helps to generate the needed converging zone.

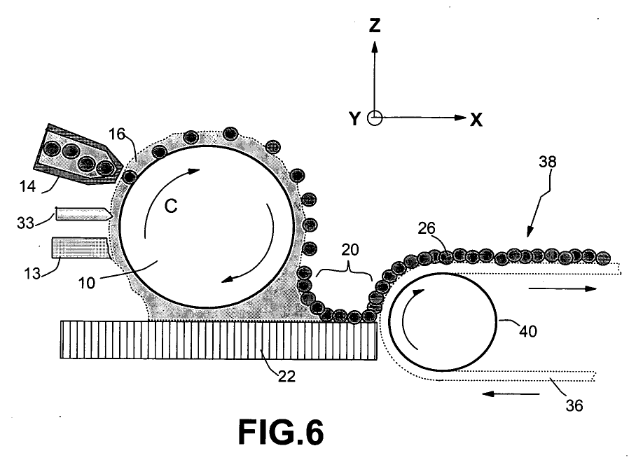

We have found that this arrangement is applicable to both the presently invented process and the process similar to that proposed by Picard, et al. As shown in FIG. 6, the assembly on the left hand side is similar to that of Picard, et al, but a second rotary member 40 is used in our apparatus to impart a more effective converging action at zone 20. This configuration appears to work well for both regularly- and irregularly-shaped particles. We have found that the apparatus shown in FIG. 1 worked, with very little success, for the formation of a monolayer from irregularly shaped particles. However, when provided with a second rotary member to facilitate converging, the apparatus worked very well even with irregularly shaped particles. This leads to another preferred embodiment, which is a major improvement over the prior art technique. This improved method includes: (a) injecting a thin liquid film containing said particles onto an external surface of a first rotary member; (b) adjusting a surface charge density of the particles through the injection of an adsorption reagent, thereby carrying the particles to a gas-liquid interface of the thin liquid film; (c) providing a converging zone to gradually form a monolayer of the particles on the gas-liquid interface and a supporting surface; and (d) transferring the monolayer from the gas-liquid interface or the supporting surface to a surface of a solid substrate which is driven by a second rotary member.

Several types of meso-scaled particles were used for practicing the invented methods. These include spherical polystyrene particles (approximately 1.5 μm), spherical ZnO particles (50-60 nm), and carbon particles (20-30 nm) surface-dispersed with platinum catalysts (2-3 nm). The latter Pt-coated carbon particles are irregular in shape and non-uniform in sizes. They are commonly used in the preparation of membrane-electrode assemblies for proton exchange membrane (PEM) fuel cells, including hydrogen gas PEM fuel cells, direct methanol fuel cells, and direct ethanol fuel cells. Since Pt is an expensive noble metal, the fuel cell industry has been making efforts to reduce the Pt catalyst quantity in terms of the Pt weight per unit area of PEM.

### EXAMPLE 2

In a laboratory-scale apparatus, a glass cylinder of 6 mm in diameter and 50 mm in length was prepared by polishing its surface with fine abrasives until no scratch line could be seen with an optical microscope at a magnification of 1,000×. A hemi-cylindrical trough was obtained by cutting out and drilling a 10×3.5×0.5 cm PTFE plate. A DC electric motor with a speed control up to 5 Hz was used to drive the glass cylinder. The cylinder was held horizontally by two PTFE circular plates drilled at 2 mm from the center. The gap between the cylinder and the trough could be adjusted to about 300 μm by simply rotating the circular plates. After a vertical position was found, the circular plates were clamped firmly on a rigid plastic structure.

Spherical polystyrene particles (beads of approximately 1.5 μm in diameter) were dispersed in water containing 0.1% by weight surfactant to form a suspension. The suspension was sprayed line by line across the transverse direction (Y-direction in FIG. 2) onto a rotating drum. Initially, the beads appeared on the air-liquid interface and were more or less separated from one another. While traveling downward from the peak of the drum surface, these particles began to be compressed and converged to form a monolayer. The water thin film was found to be approximately 3 μm in thickness.

### EXAMPLE 3

Nanometer-sized ZnO particles were prepared at Nanotek Instruments, Inc. (Fargo, N. Dak.) using a twin-wire arc technique. The particles were dispensed, using an ultrasonic wave based powder feeder, onto a thin liquid (water) film on the external surface of a rotary cylinder, as described in Example 2, but with a second rotary member as shown in FIG. 5. A well-organized monolayer was obtained from these particles that were approximately 50-60 nm in size.

### EXAMPLE 4

One of the important aspects of a PEM-based fuel cell is the membrane-electrode assembly (MEA). The MEA typically includes a PEM bonded between two electrodes (an anode and a cathode). Usually, both the anode and the cathode each contain a catalyst, often a noble metal (e.g., platinum, Pt) or a combination of a noble metal and rare-earth metal (e.g., ruthenium, Ru). These noble metals, in the form of nanometer-sized particles, are typically supported on slightly larger carbon particles that are irregular in shape. Known processes for fabricating high performance MEAs include painting, spraying, screen-printing and hot-bonding catalyst layers onto the electrolyte membrane and/or the electrodes. These known methods can result in catalyst loading on the membrane and electrodes typically in the range from about 4 mg/cm² to about 12 mg/cm² (recently have been reduced to 0.3-1.0 mg/cm²). Since noble metals such as platinum and ruthenium are extremely expensive, the catalyst cost can represent a large proportion of the total coat for a fuel cell. Therefore, there exists a need for reducing the amount of deposited catalyst, and hence the cost.

A carbon ink was prepared by first dissolving 1.2 grams of nonionic surfactant (Triton X-100) in 60 grams of distilled water (2% w/w solution) in a glass jar with a PTFE mixing bar. Six grams of platinum-supported carbon (Vulcan XC-72R, 20% Pt, E-tek) was added to the solution. The mixture was stirred with moderate agitation to form a viscous particle dispersion. About 60 grams of distilled water was added to reduce the viscosity. A small quantity of this catalyst ink was then spray-coated to both sides of a Nafion sheet. After removal of the liquid, the resulting catalyzed membrane was found to have a platinum loading of 0.5 mg/cm². This catalyzed membrane was combined with two sheets of carbon paper, acting as the anode and cathode, respectively, to form a basic fuel cell unit, herein referred to as the baseline sample.

The same catalyst ink, a suspension, was then dispensed onto the rotating cylinder as shown in FIG. 7. The resulting monolayer adsorbed on one surface of a Nafion sheet was found to contain a platinum loading of less than 0.01 mg/cm². The opposite surface of this Nafion sheet was then coated with a monolayer of same carbon-supported Pt in a similar manner. The subsequently prepared basic fuel cell unit is referred to as sample A.

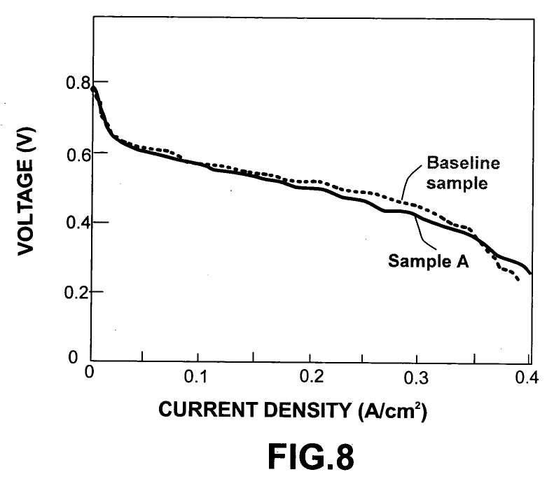

The cell voltage-current density responses of sample A and the baseline sample, under comparable operating conditions, are shown in FIG. 8. Sample A contains a 50 times smaller amount of expensive platinum, yet exhibits a strikingly comparable performance as compared to the baseline sample. It is essential for the Pt catalyst particles to be in contact with the PEM so that the protons produced at the catalyst sites can be used in the energy production process. The monolayer prepared by the presently invented method appears to meet this highly stringent requirement. In contrast, the majority of Pt in a thick catalyst layer as prepared by prior-art techniques did not contribute to the production of usable protons (that could cross the PEM layer to the cathode side). Further, a significant proportion of catalyst particles appeared to stay inside the bulk of the prior-art thick catalyst layer and, hence, were rendered inactive or ineffective. This example vividly demonstrates the advantage of the presently invented monolayer production method.

1. A method for the preparation of a monolayer of meso-scaled particles, comprising:
(A) providing a thin liquid film onto an external surface of a rotary member;
(B) dispensing meso-scaled particles at a desired rate onto an external surface of said thin liquid film so that said particles are positioned at an gas-liquid interface;
(C) forming a uniform monolayer of said particles on said gas-liquid interface; and
(D) transferring said monolayer from the gas-liquid interface to a solid substrate by moving said rotary member in a longitudinal direction relative to said substrate, thereby separating said monolayer from said thin liquid film and adsorbing said monolayer to said substrate.

2. The method according to claim 1, wherein said substrate comprises a flexible substrate material in a film or sheet form that is fed from a roll.

3. The method according to claim 2, wherein said flexible substrate material, after being adsorbed with said monolayer in step (D), is collected on a take-up roller.

4. The method according to claim 1, wherein said substrate is hydrophilic.

5. The method according to claim 1, wherein said substrate comprises a material selected from the group consisting of a clean glass plate, a mica sheet, a quartz, a semiconductor, a metal, a polymer, a composite, and a solid electrolyte membrane.

6. The method according to claim 1, wherein said substrate is hydrophobic and wherein said rotary member moves longitudinally in a direction opposite to the rotation direction of said rotary member.

7. The method according to claim 1, wherein said particles comprise a material selected from the group consisting of a ceramic, glass, metal, metal alloy, carbon, graphite, polymer, composite, and combinations thereof.

8. The method according to claim 1, wherein said particles comprise irregularly-shaped particles.

9. The method according to claim 1, wherein said particles comprise catalyst particles and said substrate comprises a solid electrolyte membrane to produce a catalyst-coated membrane for use in a fuel cell.

10. The method according to claim 1, wherein said thin liquid film has a thickness in the range of 0.1 to 10 microns.

11. The method according to claim 1, further comprising a step of treating said monolayer and/or said substrate to promote bonding, adhesion, or intimate contact between said monolayer and said substrate.

12. The method according to claim 11, wherein said step of treating comprises exposing said monolayer and/or said substrate to a high energy beam selected from the group consisting of ultraviolet light, infrared light, microwave, radio frequency, plasma, electron beam, ion beam, laser, radiant heat, convective heat, conduction heat, heat transferred from a heated roller, and combination thereof.

13. A method for the preparation of a monolayer of meso-scaled particles, comprising:
(A) providing a thin liquid film onto an external surface of a first rotary member;
(B) dispensing meso-scaled particles at a desired rate onto an external surface of said thin liquid film so that the particles are positioned at a gas-liquid interface;
(C) providing a converging zone on which said particles are compressed to form a monolayer which is gradually separated from said gas-liquid interface; and
(D) transferring said monolayer from said converging zone to a solid substrate.

14. The method according to claim 13, wherein step (D) comprises transferring said monolayer to a surface of said solid substrate which is driven by a second rotary member.

15. The method according to claim 13, further comprising a step of treating said monolayer and/or said substrate to promote bonding, adhesion, or intimate contact between said monolayer and said substrate.

16. A method for the preparation of a monolayer of meso-scaled particles, comprising:
(a) injecting a first liquid to form a thin liquid film on an external surface of a rotary member, wherein said first liquid is a non-solvent to a desired solid component;
(b) injecting a solution, comprising said solid component dissolved in a liquid solvent, onto said thin liquid film, thereby causing said solid component to precipitate out in the form of meso-scaled particles at a gas-liquid interface of said thin liquid film;
(c) forming a uniform monolayer of said particles on said gas-liquid interface; and
(d) transferring said monolayer from the gas-liquid interface to a solid substrate.

17. The method according to claim 16, wherein step (d) comprises moving said rotary number in a longitudinal direction relative to said substrate, thereby separating said monolayer from said thin liquid film and adsorbing said monolayer to said substrate.

18. A method for the preparation of a monolayer of meso-scaled particles, comprising:
(a) injecting a thin liquid film containing said particles onto an external surface of a first rotary member;
(b) adjusting a surface charge density of said particles through the injection of an adsorption reagent, thereby carrying said particles to a gas-liquid interface of said thin liquid film;
(c) providing a converging zone to gradually form a monolayer of said particles on said gas-liquid interface and a supporting surface; and
(d) transferring said monolayer from the gas-liquid interface or the supporting surface to a surface of a solid substrate which is driven by a second rotary member.

19. The method according to claim 18, wherein said particles comprise irregularly-shaped particles.

20. The method according to claim 18, wherein said particles comprise catalyst particles and said substrate comprises a solid electrolyte membrane to produce a catalyst-coated membrane for use in a fuel cell.
